(19) United States
(12) Patent Application Publication
(10) Pub. No.: US 2024/0058993 A1
(43) Pub. Date: Feb. 22, 2024

(54) METHOD FOR RECYCLING WASTE IN THE FORM OF FLAKES

(71) Applicant: REPLACE, Woippy (FR)

(72) Inventors: Laurent Robert VILLEMIN, Woippy (FR); Christian HORN, Weiswampach (LU); Etienne HERMANT, Châlons-en-Champagne (FR)

(21) Appl. No.: 18/260,687

(22) PCT Filed: Jan. 7, 2022
(86) PCT No.: PCT/EP2022/050273

§ 371 Date: Jul. 7, 2023

(30) Foreign Application Priority Data
Jan. 11, 2021 (FR) 2100208

(51) Int. Cl. B29B 17/00

(52) U.S. Cl. CPC B29B 17/0042; B29K 2105/26

(57) ABSTRACT

The invention relates to a method for recycling waste in the form of flakes containing plastics-based materials, the flakes; —compacting the flakes and feeding them into a plasticizing tool; —melting and kneading the flakes in the plasticizing tool; —injecting the extruded material under high pressure into a mould to form a component; —using the decomposition gases generated by the heating and the pressurizing of the material recycled in the plasticizing tool to lubricate the material as it is injected into the mould and to compensate for the shrinkage of the material as it cools without supplying additional gas; —cooling the mould; —extracting the component from the mould.

The present application claims the priority of French prior application FR 2100208 filed on Jan. 11, 2021 in the name of REPLACE, the contents of this prior application being incorporated by reference, in its entirety, in the present application.

The present invention relates to the field of waste recycling. More precisely, the present invention relates to a method for transforming a raw material which is in the form of multicomponent plastic ground materials or granules into solid or hollow 3D parts, without the need for prior sorting of the raw material.

### PRIOR ART

Publication FR 2 428 518 discloses a method for transforming a synthetic thermoplastic material, in particular unsorted synthetic thermoplastic waste, into an item having the working and usage properties of wood. In this document, the aim of the invention described is to provide a method for transforming a synthetic thermoplastic material into a shaped item, in which a pressure-resistant apparatus is not necessary but, on the contrary, apparatuses and dies or molds are used which are not pressure-resistant and are commercially available.

In FR 2 428 518, a method is proposed for transforming a synthetic thermoplastic material, in particular unsorted synthetic thermoplastic waste, into an item having the working and processing properties of wood, wherein the synthetic material undergoes a mixing operation in a barrel comprising a screw member, is rendered fluid, molded, cooled in the mold and removed from the mold, characterized by the fact that the synthetic material feeds an extrusion apparatus without a screen grid and without an extrusion die, and is kept there until a material is obtained which is rendered fluid by the temperature increase, this material containing a gas when it leaves the extrusion apparatus and then passing into a mold which is open at its opposite ends, one of which is connected to the outlet of the extrusion apparatus.

The method according to FR 2 428 518 can be executed by the use of any known commercially available screw extrusion apparatus, which may be of the adiabatic type or normal type but the pressure generating elements of which (normally resulting in pressures of 100-450 kg/cm²), in other words the screen pack or the exchanger and the extrusion die, must be removed. The screw-type extruder is thus essentially a screw conveyor, approximately like a meat grinder. The molding operation, which in the method according to FR 2 428 518 is carried out in a separate phase, must be performed in an open mold. Since the material to be molded is introduced without pressure, it is possible to use tubes of simple standard quality with round or rectangular cross section in order to make, for example, round or rectangular posts or beams. The filling pressure of the mold is provided in the method according to the invention by the molding gas available in the fluid material to be molded. The molding gas is obtained by providing the divided synthetic material, intended to feed the extruder, with a blowing agent, the threshold temperature of which is exceeded by the temperature established in the extruder. Suitable blowing agents are, for example, granulated solid blowing agents having a threshold temperature of 150-270° C., for example azodicarbonamide (200° C.), diphenyl sulfone 3,3′-di-sulfonyl hydrazide (150° C.), β-β-oxybis(benzenesulfonyl semicarbazide) (210° C.). The proportion of blowing agent can be determined by tests and it depends, inter alia, on the shape of the final product and the properties of the thermoplastic material. Suitable proportions range from 0.4 to 1.2%, calculated with respect to the weight of the mixture of thermoplastic material and blowing agent.

In this publication, when a gas is used as molding gas, for example nitrogen or air, this gas is provided to the extruder after the synthetic thermoplastic material has been rendered fluid.

The method according to FR 2 428 518 has many advantages, in particular it is not critical. By using existing control means for normal commercially available screw extruders, the entire treatment can be easily controlled. Since an adiabatic extruder has smaller dimensions, this type is preferred because it requires less expenditure. Since a screen pack is not used in the screw extruder, there is practically no risk of obstruction of the apparatus, so that the synthetic thermoplastic resin material to be treated does not need to be washed or purified beforehand. The method according to FR 2 428 518 is also not particularly critical with regard to the composition of the starting material, even to the extent that unsorted mixtures of different synthetic thermoplastic resin materials can be treated satisfactorily. Since no pressure is established in the apparatus in which the method according to the invention is carried out, the apparatus does not need to meet any special requirements, for example with regard to the geometry of the screw. The molds also do not need to meet any special requirements with regard to pressure resistance, so that molds of standard commercial quality can be used.

### DISCLOSURE OF THE INVENTION

One of the aims of the invention is to improve the known methods.

More particularly, an aim of the invention is to propose a method for recycling materials originating from waste.

Within the scope of the present invention and according to embodiments thereof, a method and a production unit have been developed, enabling multicomponent plastic granules or ground materials (generally referred to as “flakes” in the remainder of the present description) to be transformed into solid or hollow 3D parts, for example of cross section between 1 cm² and 1600 cm², preferably between 4 cm² and 200 cm² and of length 0.3 m to 10 m and preferably 0.5 m to 6 m. These values are of course indicative and not limiting.

The materials used and present in these ground materials or granules are mainly plastics-based materials mixed with other materials: for example aluminum or other metals, inks, varnishes, glues, wood, glass fibers or other types of fibers described in the present application. The plastic part is of the order of 30% to 100%, preferably 40% to 90% by volume, approximately.

Within the scope of the present invention, the injection of the extruded material is carried out at a high pressure, for example of the order of 50 bar to 2000 bar, preferably between 100 bar and 1500 bar. This high pressure allows a long flow length in the mold which is facilitated by lubrication of the material as explained below.

The technical innovations of the method enable this continuous transformation at flow rates between 0.05 m³/h and 2 m³/h, and preferably between 0.1 m³/h and 1 m³/h, and therefore at lower production costs than the production costs of conventional extrusion and plastic injection processes.

The products produced by the method according to the invention are themselves considered recyclable because they are reusable through the same method after simple grinding in order to form flakes.

The present invention will be better understood with the aid of the following description of embodiments thereof and the claims. In said claims, embodiments of the invention are defined by the independent claims, and the dependent claims define particular embodiments.

According to embodiments of the invention, ground waste of diverse products is used as raw material. Typically, the materials used are mainly polyolefin-based materials mixed with other materials: for example metals such as aluminum, inks, varnishes, glues, wood, glass fibers or other types of fibers. For example, this waste is composed of packaging tubes comprising a barrier layer. These tubes are ground and form this raw material which is used without prior sorting.

Within the scope of the present invention, the injection of the extruded material is carried out at a high pressure, for example as described above from 50 bar to 2000 bar. This high pressure allows a long flow length in the mold which is facilitated by lubrication of the material resulting from this high pressure.

According to another aspect of the present invention, the method is carried out without degassing the extruded material or else by carrying out partial degassing of the material, the aim being to use the gases generated by the material. Indeed, in the prior art, it is usual to add a gas in the mold, or else specific foaming agents in the extruded material, in order to compensate for shrinkage of material during cooling in the mold. Within the scope of the present invention, it has surprisingly been found that this addition of gas or agents can be omitted and that it is possible, on the contrary, to benefit from the presence of certain materials in the waste which will themselves generate gases while being heated for extrusion, and to use these gases to avoid shrinkage. For example, gases can be generated by inks and/or varnishes and/or glues and/or other products present in or on the material used to form the flakes.

In another aspect of the invention, it is also possible to add fibers in the material in order to increase the rigidity of the parts produced by the method. This addition can be performed at various times (for example at the start or end of extrusion) as described below and the fibers are for example glass fibers, plant fibers (hemp etc.), cotton fibers, etc.

In some embodiments, the invention relates to a method for recycling waste in the form of flakes containing plastics-based materials, characterized in that it comprises the following steps:
taking up the flakes;
compacting the flakes and feeding them into a plasticizing tool;
melting and mixing said flakes in the plasticizing tool;
injecting the extruded material under high pressure into a mold to form a part;
using the decomposition gases generated by the heating and the pressurizing of the recycled material in the plasticizing tool to lubricate the material as it is injected into the mold and to compensate for the shrinkage of material during cooling, without supplying additional gas;
cooling the mold;
removing the part from the mold.

In some embodiments, the flakes can come from at least two sources of recycled materials.

In some embodiments, a first source generates decomposition gases, preferably at a temperature higher than 60° C.

In some embodiments, the first source preferably comprises plastic resin-based materials.

In some embodiments, the second source preferably contains fillers such as aluminum fibers or particles, metals, fibers, inks, adhesives, varnishes, mineral fillers, oils, packaged product waste and washing waste. Other equivalent materials are possible.

In some embodiments, the second source comprises toothpaste tubes and/or champagne bottle caps and/or motor vehicle bumpers and/or dashboards.

In some embodiments, flakes from various sources are preferably fed simultaneously to an inlet of the plasticizing tool.

In some embodiments, flakes from various sources are preferably fed successively into the plasticizing tool.

In some embodiments, flakes from various sources are likewise preferably fed successively into the plasticizing tool.

In some embodiments, the apparent density of the flakes is preferably between 0.1 and 2.

In some embodiments, the molten material is injected into a mold, preferably at a flow rate of 0.1 m³/h to 10 m³/h.

In some embodiments, the molten material is injected into a mold at a pressure preferably of the order of 50 bar to 2000 bar.

In some embodiments, partial degassing of the extruded material is carried out.

In some embodiments, degassing of the part is carried out after its removal from the mold.

In some embodiments, the invention relates to a part obtained according to a method as defined in the present application.

In some embodiments, the part obtained comprises materials from at least one source of recycled materials.

In some embodiments, the source comprises synthetic resin-based materials.

In some embodiments, the materials used are, for example, mainly polyethylene-based or polyolefin-based, mixed with other materials such as metal, inks, varnishes, glues, wood, glass fibers or packaging tubes comprising a barrier layer.

In some embodiments, the second source comprises fillers such as aluminum fibers or particles, metals, fibers, inks, adhesives, varnishes, mineral fillers, oils, packaged product waste and washing waste, toothpaste tubes and/or champagne bottle caps and/or motor vehicle bumpers and/or dashboards.

In some embodiments, the part obtained is, for example, an object such as a post, a pole, a profile, a stake, a board or another equivalent object.

### BRIEF DESCRIPTION OF THE DRAWINGS

FIG. 1 illustrates a block diagram of an embodiment of the invention.

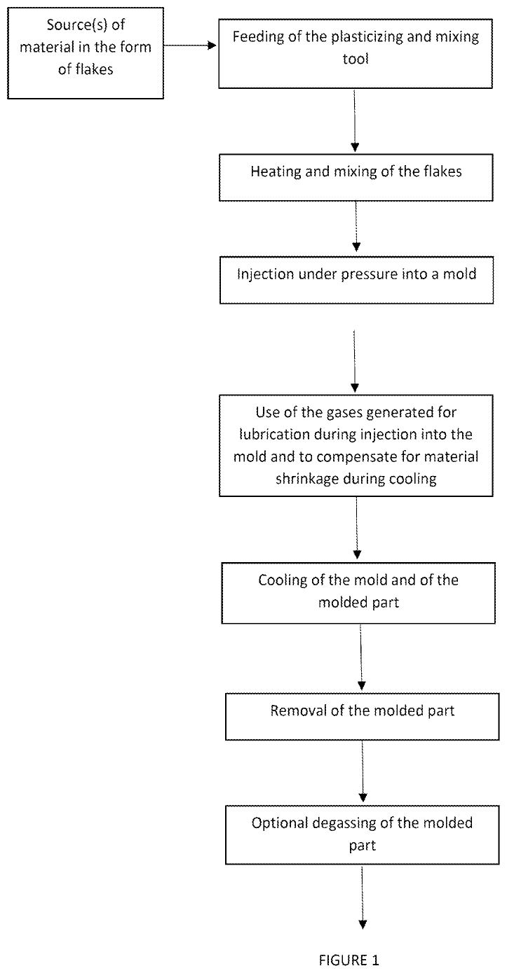

FIG. 2A illustrates an example of an object obtained by the method according to the invention and FIGS. 2B to 2E illustrate examples of cross sections perpendicular to the longitudinal axis of said object.

### DETAILED DESCRIPTION OF THE INVENTION

Within the scope of the present invention, waste from objects made of plastics material, that may or may not be cleaned, and ground into the form of flakes having a bulk apparent density between 0.1 and 2 and preferably between 0.2 and 1.5 is used directly. Due to their low apparent density, it is difficult to use these flakes of recycled material directly in conventional extrusion or thermoplastic resin injection methods. The method developed according to the invention therefore preferably comprises a first phase of compacting or forcing flakes of recycled material in order to increase their apparent density when they are fed into the plasticizing method.

Within the scope of the invention, waste from plastic objects from various sources is advantageously used. The mixing of plastic waste from various sources and in controlled proportions has many advantages as described in the present application.

A first advantage of the invention is to allow a rapid adjustment of the proportions of the mixture according to the production to be carried out and the desired properties of the product obtained by the method. For example, the invention makes it possible to adjust the modulus of rigidity of the object, its resistance to stress cracking, its density, its resistance to impacts, its hardness or even its thermal resistance by acting on the raw material used. For this purpose, various sources of recycled waste are favored. In the method, the first source substantially comprises plastic resin-based materials. An advantageously used first source of waste is substantially composed of polyethylene, for example multi-layer packaging made of plastic-aluminum or different types of plastics which do not mix together (for example PE-PET, PP-PET mixes). Of course, other equivalent first sources of material are possible. A second source advantageously used in embodiments of the invention contains metal and/or fibrous particles, for example aluminum particles and/or glass fibers. According to the invention, the second source contains fillers such as aluminum fibers or particles, metals, fibers, inks, adhesives, varnishes, mineral fillers, oils, packaged product waste and washing waste or other equivalent fillers. A non-limiting example of a second source of waste containing aluminum particles is the toothpaste tube with a multi-layer plastic-aluminum structure. Another non-limiting example of a second source is champagne bottle caps. Purge materials used in injection or even waste from the automotive industry such as bumpers and dashboards, for example, can be used as a source of fibrous waste.

A second advantage of the invention resulting from the use of plastic waste from a plurality of sources is an unexpected effect, which is of great interest both for the method for manufacturing recycled objects itself, but also for the esthetic quality of the objects produced. Indeed, it has been observed that certain waste or components present in or on the waste and flakes had a tendency to generate gases in the method for manufacturing recycled objects. In the plastic materials processing industry, these gases coming from an involuntary decomposition mechanism under the effect of heat are usually separated from the resin before manufacturing the object. This separation step is implemented, in particular, in what are referred to as “compounding” methods which enable thermoplastic resins to be formulated by adding fillers, for example, or by mixing polymers. In these compounding methods, degassing is carried out during or after the mixing in order to extract the gases coming from the decomposition.

By contrast, in the method according to the invention, it is attempted to retain these gases, or at least part of these gases, from the decomposition, for the beneficial effect that they contribute to the method. A first beneficial effect is the reduction in viscosity of the product injected into the mold, because these decomposition products are in the liquid state when they are subjected to high pressures in the plasticizing and injection tool. These pressures are typically between 100 bar and 1000 bar. These decomposition products remain in the liquid state when the pressure is higher than several bar, for example approximately 5 bar. Consequently, there is great interest in retaining these decomposition products in the transformed product because their low viscosity in the liquid state makes it possible to lubricate the polymer chains and significantly re-duce the viscosity of the material. This effect has a double benefit, namely, on the one hand, reducing the energy consumed for the manufacture of said recycled objects and, on the other hand, providing the possibility of manufacturing objects of long length with a reduced cross section (such as poles, posts, profiles etc.).

The second beneficial effect of the decomposition products is linked to the change of state from liquid to gas once the pressure is sufficiently reduced. Consequently, and contrary to the publications of the prior art which propose adding blowing agents, the invention advantageously uses the decomposition products which transform into gas when the injected object cools: the expansion force generated by the gases is then used to compensate for the shrinkage of the molded material during cooling. This results in molded objects with high visual quality and high dimensional precision, while the cycle time is greatly reduced and simplified.

In the method according to the invention, the method preferably comprises an initial step of forcing flakes of recycled objects; the forcing step having the effect of increasing the apparent density in the solid state of the flakes at the time of feeding them into the plasticizing and mixing tool.

In the method, flakes coming from at least one source are used, or flakes coming from at least two different sources are mixed in a controlled quantity, in order to adjust the properties of the injected material according to the use properties of the manufactured object. A single source may be sufficient to form an object with the desired characteristics, or else it may be necessary to use different sources of materials.

When more than one source is used, a first method consists in feeding the flakes from the different sources simultaneously to the inlet of the plasticizing tool.

A second method consists in feeding each source of flakes successively into the plasticizing tool. This second method makes it possible to meter in each product at the optimum location in the plasticizing tool. For example, it may be advantageous to incorporate a recycled product comprising fibers into a first recycled product that is already in the molten state, in order to limit the degradation of the fibers.

A third method consists in a mixture of the first and second method, when the number of sources is greater than two. Hence, it is possible to have, for example, products 1 and 2 (sources 1 and 2) fed simultaneously to the inlet of the plasticizing tool, and a product 3 (source 3) fed into the plasticizing tool further downstream. Of course, this is a non-limiting example and it is possible, in another embodiment, to feed a single source to the inlet of the tool and the two other sources further downstream. Multiple combinations are therefore possible within the scope of the present invention.

In the method according to the invention, the plasticizing tool enables the incorporation, mixing and melting of recycled products coming from at least one source in order to ultimately obtain a homogeneous molten material that is ready for injection. During the method according to the invention, the decomposition products are retained in the liquid state in the mixture during the plasticizing operation, by virtue of a pressure in the device that is kept higher than 5 bar after melting.

In the method according to the invention, the pressure on the molten material is at least 5 bar during the transfer of the material from the plasticizing unit before injection.

In the method according to the invention, the molten material is injected into a mold at a flow rate of 0.1 m³/h to 10 m³/h and advantageously of 0.5 m³/h to 5 m³/h. Due to the high flow rate during injection, the filling time is low and the pressure in the material during filling of the mold remains higher than 5 bar. For this reason, the decomposition products remain in the liquid state and play a lubricating role, enabling the pressure necessary for filling the cavity to be reduced. Through this phenomenon, the invention enables molding of objects of long flow length having a reduced cross section.

In the method according to the invention, the molds are filled cold. After injection, the recycled material, on cooling in the cavity of the mold, solidifies which causes a reduction in volume and consequently a reduction in the pressure inside the material. This pressure reduction enables the decomposition products to pass from the liquid state to the gaseous state and to generate a “core foaming” pressure during the cooling and solidification of the object. This foaming pressure creates cavities distributed through the core of the object in the central part of the object, the peripheral part being devoid of such cavities. According to the invention, the density of the central part of the object is much lower than the density of the peripheral part, which has many advantages in terms of the mass and use properties of the object obtained by the method. Another advantage of the invention is the obtainment of recycled parts of good visual quality due to its surface state, and of high dimensional precision due to the compensation of shrinkage through the “core foaming” effect.

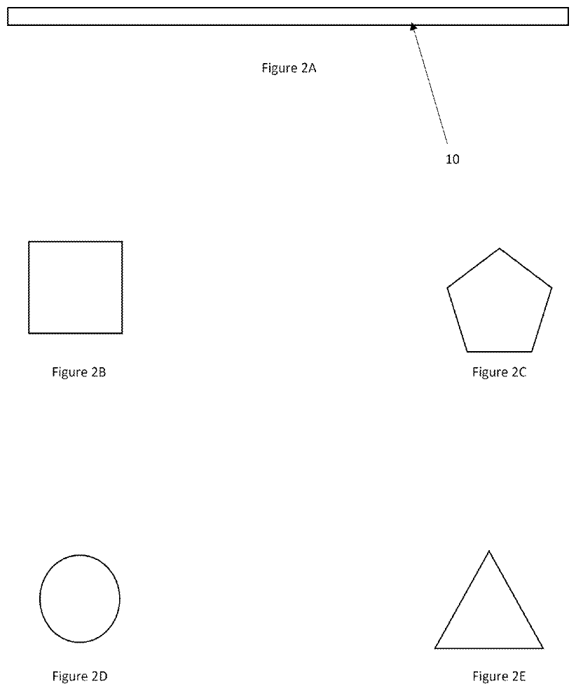

According to a preferred embodiment of the invention, the method is used to manufacture elongate solid or hollow objects 10, such as vine poles, poles for road signs, profiles or other similar objects. Examples in side view and in cross sections perpendicular to the longitudinal axis are illustrated in FIGS. 2A to 2E which show the profiles of these parts 10. Of course, these are illustrative examples and other shapes and profiles are possible within the scope of the present invention.

An advantage of the method according to the invention is linked to the fact that the objects produced do not have burrs and are usable directly.

In general, according to the invention, the method for recycling waste in the form of flakes containing plastic resin-based materials mixed with other materials, such as metals, fibers, inks, adhesives, varnishes, mineral fillers, oils, packaged product waste and washing waste, comprises the following steps:
taking up the flakes;
compacting the flakes;
melting and mixing said flakes in an extruder (as a mixing and plasticizing tool);
injecting the extruded material under high pressure into a mold to form a part;
using the decomposition gases generated by the heating and the pressurizing of the recycled material in the plasticizing tool to lubricate the material as it is introduced into the mold and to compensate for shrinkage of material during cooling, without supplying additional gas;
cooling the mold;
removing the part 10 from the mold.

According to some embodiments, the method according to the invention comprises at least the following steps:
using at least two sources of recycled material; a first generating decomposition products at a temperature higher than 60° C. and preferably at a temperature higher than 80° C.; and a second containing fillers such as aluminum fibers or particles.
transforming the waste into flakes of apparent density between 0.1 and 2; feeding flakes from the respective sources in a controlled proportion in order to obtain a recycled product having the desired properties (for example rigidity, stress cracking, density, resistance to impacts, hardness, thermal resistance, appearance).
forcing the flakes in the solid state in order to increase their apparent density.
plasticizing and mixing the recycled material using an extruder, the products from the decomposition are retained due to a pressure in the extruder higher than 5 bar when the material is molten,
injecting the molten material into a mold at a flow rate of 0.1 m³/h to 10 m³/h and advantageously of 0.5 m³/h to 5 m³/h. An optional compacting phase after injection.
cooling the molded part 10 in the mold: the pressure in the mold reduces, the decomposition products change state (from liquid to gas), the pressure generated by the decomposition gases makes it possible to compensate for shrinkage of the material which cools.
demolding the molded part 10 which exhibits no shrinkage or appearance defect.

According to some embodiments of the present invention, an optional degassing phase of the objects is carried out, performed after the manufacture of the molded part or molded object. This degassing phase has the effect and advantage of limiting the release of gas and odors during the life of the objects. The degassing phase of the objects is carried out, for example, by storing the molded objects in an enclosure, the temperature of which is between 40° C. and 100° C. and preferably between 60° C. and 80° C., and for a duration between 8 hours and 72 hours and preferably between 12 hours and 48 hours.

### Examples

Tables 1 to 6 below show examples of compositions of ground materials used in the method according to the invention, according to thirteen tests and eight tests, respectively. Tables 1 to 3 respectively illustrate the details of the composition, the composition by volume and the results for tests 1 to 13a. Tables 4 to 6 respectively illustrate the details of the composition, the composition by volume and the results for tests A to H.

TABLE 1

| | | | Aluminum | | |
|---|---|---|---|---|---|
| | | | champagne | PP from | |
| | HDPE | | cap, thickness | recycled | |
| | colored | | 70 microns | material | |
| Test | bottle post | Toothpaste | (total thickness | extrusion | Reinforcing |
| No. | consumption | tubes | 130 microns) | purges | fiber |
| 1 | 65% | 22% | | | 13% |
| la | 75% | 25% | | | |
| 2 | | 65% | | 22% | 13% |
| 2a | | 75% | | 25% | |
| 3 | | 22% | | 65% | 13% |
| 3a | | 25% | | 75% | |
| 4 | 22% | 65% | | | 13% |
| 4a | 25% | 75% | | | |
| 5 | | 87% | | | 13% |
| 5a | | 100% | | | |
| 6 | 65% | | 22% | | 13% |
| 6a | 75% | | 25% | | |
| 7 | 22% | | 65% | | 13% |
| 7a | 25% | | 75% | | |
| 8 | | | 87% | | 13% |
| 8a | | | 100% | | |
| 9 | | 52% | | 35% | 13% |
| 9a | | 60% | | 40% | |
| 10 | 35% | 52% | | | 13% |
| 10a | 40% | 60% | | | |
| 11 | | 36% | | 54% | |
| 11a | | 40% | | 60% | |
| 12 | | 17% | 70% | | 13% |
| 12a | | 20% | 80% | | |
| 13 | | | 70% | 17% | 13% |
| 13a | | | 80% | 20% | |

TABLE 2

| | | PE part | | | | |
|---|---|---|---|---|---|---|
| | | (HDPE, | | | | Various |
| | | LDPE, | | Adhesives/ | | contami- |
| Test | Aluminum | LIN, | PP | inks/ | | nation |
| No. | part | etc.) | part | varnishes | Fiber | materials |
| 1 | 1.2% | 81.0% | 4.3% | <1% | 13.0% | |
| 1a | 1.4% | 93.0% | 5.0% | <1% | 0.0% | |
| 2 | 3.5% | 59.0% | 20.0% | <1% | 13.0% | 4.4% |
| 2a | 4.1% | 67.9% | 23.0% | <1% | 0.0% | 5.0% |
| 3 | 1.2% | 18.7% | 54.0% | <1% | 13.0% | 13.0% |
| 3a | 1.4% | 21.3% | 62.0% | <1% | 0.0% | 15.0% |
| 4 | 3.5% | 79.0% | 4.3% | <1% | 13.0% | |
| 4a | 4.1% | 90.0% | 5.0% | <1% | 0.0% | |
| 5 | 4.7% | 75.0% | 5.0% | <2% | 13.0% | |
| 5a | 5.5% | 86.0% | 6.0% | <2% | 0.0% | |
| 6 | 11.8% | 75.0% | | <1% | 13.0% | |
| 6a | 13.5% | 86.0% | | <1% | 0.0% | |
| 7 | 35.0% | 51.0% | | <2% | 13.0% | |
| 7a | 40.4% | 58.0% | | <2% | 0.0% | |
| 8 | 46.8% | 39.0% | | <2% | 13.0% | |
| 8a | 53.8% | 45.0% | | <2% | 0.0% | |
| 9 | 2.8% | 44.4% | 24.4% | <1% | 13.0% | 7.0% |
| 9a | 3.3% | 51.0% | 28.0% | <1% | 0.0% | 8.0% |
| 10 | 2.8% | 79.1% | 4.0% | <1% | 13.0% | 0.0% |
| 10a | 3.3% | 91.0% | 5.0% | <1% | 0.0% | 0.0% |
| 11 | 2.0% | 30.8% | 37.9% | <1% | 13.0% | 10.8% |
| 11a | 2.2% | 34.0% | 42.0% | <1% | 0.0% | 12.0% |
| 12 | 38.4% | 44.0% | 3.0% | <2% | 13.0% | |
| 12a | 44.2% | 51.0% | 3.0% | <2% | 0.0% | |
| 13 | 37.4% | 31.0% | 13.9% | <2% | 13.0% | 3.5% |
| 13a | 43.1% | 35.5% | 16.0% | <2% | 0.0% | 4.0% |

TABLE 3

| Test | | |
|---|---|---|
| No. | Appearance | RIGIDITY |
| 1 | Good appearance | Rigid |
| la | Good appearance | Low rigidity |
| 2 | Good appearance | Medium rigidity |
| 2a | Good appearance | Low rigidity |
| 3 | Good appearance | Very rigid |
| 3a | Good appearance | Medium rigidity |
| 4 | Good appearance | Medium rigidity |
| 4a | Good appearance | Low rigidity |
| 5 | Good appearance | Low rigidity |
| 5a | Good appearance | Very low rigidity |
| 6 | Good appearance | Rigid |
| 6a | Good appearance | Medium rigidity |
| 7 | Correct appearance | Very rigid but friable |
| 7a | Correct appearance | Rigid but friable |
| 8 | Incomplete appearance | Very rigid but friable |
| 8a | Incomplete appearance | Rigid but friable |
| 9 | Good appearance | Very rigid |
| 9a | Good appearance | Rigid |
| 10 | Good appearance | Rigid |
| 10a | Good appearance | Medium rigidity |
| 11 | Good appearance | Very rigid |
| 11a | Good appearance | Rigid |
| 12 | Correct appearance | Very rigid but friable |
| 12a | Correct appearance | Rigid but friable |
| 13 | Correct appearance | Very rigid but friable |
| 13a | Correct appearance | Rigid but friable |

TABLE 4

| | Aluminum | Aluminum | | |
|---|---|---|---|---|
| | champagne | champagne | PP from | |
| | cap, thickness | cap, thickness | recycled | |
| | 70 microns | 50 microns | material | |
| Test | (total thickness | (total thickness | extrusion | Reinforcing |
| No. | 130 microns) | 74 microns) | purges | fiber |
| A | 25% | | 75% | 0% |
| B | 23% | | 68% | 10% |
| C | 50% | | 50% | 0% |
| D | 45% | | 45% | 10% |
| E | | 25% | 75% | 0% |
| F | | 23% | 68% | 10% |
| G | | 50% | 50% | 0% |
| H | | 45% | 45% | 10% |

TABLE 5

| | | PE Part | | | | Various |
|---|---|---|---|---|---|---|
| | Alumi- | (HDPE, | | Adhesives/ | | “contami- |
| Test | num | LDPE, | PP | Inks/ | | nation” |
| No. | part | LIN, etc.) | Part | Varnishes | Fiber | materials |
| A | 13.5% | 11.5% | 60.0% | <1% | 0.0% | 15.0% |
| B | 12.1% | 10.4% | 54.0% | <1% | 10.0% | 13.5% |
| C | 26.9% | 23.0% | 40.0% | <1% | 0.0% | 10.0% |
| D | 24.2% | 20.7% | 36.0% | <1% | 10.0% | 9.0% |
| E | 16.9% | 8.0% | 60.0% | <1% | 0.0% | 15.0% |
| F | 15.2% | 7.2% | 54.0% | <1% | 10.0% | 13.5% |
| G | 33.8% | 16.0% | 40.0% | <1% | 0.0% | 10.0% |
| H | 30.4% | 14.4% | 36.0% | <1% | 10.0% | 9.0% |

TABLE 6

| Test | | |
|---|---|---|
| No. | Appearance | RIGIDITY |
| A | Good appearance | Rigid |
| B | Good appearance | Very rigid |
| C | Good appearance | Rigid |
| D | Good appearance | Very rigid |
| E | Good appearance | Rigid |
| F | Good appearance | Very rigid |
| G | Good appearance | Rigid |
| H | Good appearance | Very rigid |

The embodiments described are given by way of illustrative examples and should not be considered as limiting. Other embodiments may use means equivalent to those described by way of example. The embodiments can also be combined with one another according to circumstances, or means used in one embodiment can be used in another embodiment.

1. A method for recycling waste in the form of flakes containing plastics-based materials, the method comprising the following steps:
taking up the flakes;
compacting the flakes and feeding them into a plasticizing tool;
melting and mixing said flakes in the plasticizing tool;
injecting the extruded material under high pressure into a mold to form a part;
using the decomposition gases generated by the heating and pressurizing of the recycled material in the plasticizing tool to lubricate the material as it is injected into the mold and to compensate for the shrinkage of material during cooling, without supplying additional gas;
cooling the mold; and
removing the part from the mold.

2. The method as claimed in claim 1, wherein the flakes come from at least two sources of recycled materials.

3. The method as claimed in claim 2, wherein a first source generates decomposition gases at a temperature higher than 60° C.

4. The method as claimed in claim 2, wherein the first source substantially comprises plastic resin-based materials.

5. The method as claimed in claim 2, wherein the second source contains fillers such as aluminum fibers or particles, metals, fibers, inks, adhesives, varnishes, mineral fillers, oils, packaged product waste and washing waste.

6. The method as claimed in claim 2, wherein the second source comprises toothpaste tubes and/or champagne bottle caps and/or motor vehicle bumpers and/or dashboards.

7. The method as claimed in claim 2, wherein flakes from various sources are fed simultaneously to an inlet of the plasticizing tool.

8. The method as claimed in claim 2, wherein flakes from various sources are fed successively into the plasticizing tool.

9. The method as claimed in claim 2, wherein flakes from various sources are also fed successively into the plasticizing tool.

10. The method as claimed in claim 1, wherein the apparent density of the flakes is between 0.1 and 2.

11. The method as claimed in claim 1, wherein the molten material is injected into a mold at a flow rate of 0.1 m³/h to 10 m³/h.

12. The method as claimed in claim 1, wherein the molten material is injected into a mold at a pressure of the order of 50 bar to 2000 bar.

13. The method as claimed in claim 1, wherein a partial degassing of the extruded material is carried out.

14. The method as claimed in claim 1, wherein a degassing of the part is carried out after its removal from the mold.

15. A part obtained according to the method as defined in claim 1.

16. The part as claimed in claim 15, said part comprising materials from at least one source of recycled materials.

17. The part as claimed in claim 15, wherein the source comprises synthetic resin-based materials.

18. The part as claimed in claim 17, wherein the materials used are mainly polyethylene-based or polyolefin-based, mixed with other materials such as metal, inks, varnishes, glues, wood, glass fibers or packaging tubes comprising a barrier layer.

19. The part as claimed in claim 15, wherein a second source comprises fillers such as aluminum fibers or particles, metals, fibers, inks, adhesives, varnishes, mineral fillers, oils, packaged product waste and washing waste, toothpaste tubes and/or champagne bottle caps and/or motor vehicle bumpers and/or dashboards.

20. The part as claimed in claim 15, wherein said part is an object such as a post, a pole, a profile, a stake or a board.
